(19) United States
(12) Patent Application Publication
(10) Pub. No.: US 2019/0232520 A1
(43) Pub. Date: Aug. 1, 2019

(54) LINEAR GUIDE MECHANISM AND HINGE CONNECTIONS OF POWER MITER SAW

(71) Applicant: Chin-Chin Chang, Taichung City (TW)

(72) Inventor: Chin-Chin Chang, Taichung City (TW)

(21) Appl. No.: 16/377,174

(22) Filed: Apr. 6, 2019

Related U.S. Application Data
(63) Continuation-in-part of application No. 15/867,148, filed on Jan. 10, 2018, now Pat. No. 10,270,007.

(51) Int. Cl. B27B 5/20; B23D 47/02

(52) U.S. Cl. CPC B27B 5/208; B23D 47/02

(57) ABSTRACT

A power miter saw includes two linear guide mechanisms each including a first link including a bifurcated first end including two opposite first through holes; and a bifurcated second end including two opposite second through holes; a spring-loaded second link including a bifurcated first end having two opposite first through hole having a bearing recess, and a bifurcated second end including two opposite second through holes; two washers at outer ends of the first through holes of the second link respectively; a cylindrical lining in the first through holes of the second link; two bearings each at the bearing recess; and a pivot driven through the first through holes of the first link, the washers, the bearings, the cylindrical lining, and the first through holes of the second link to receive a portion of a complimentary pivot to pivotably secure the first and second links together.

### CROSS-REFERENCE TO RELATED APPLICATIONS

This application is a continuation-in-part (CIP) of U.S. patent application Ser. No. 15/867,648, filed on Jan. 10, 2018. The contents of the above application are all incorporated herein by reference.

### BACKGROUND OF THE INVENTION

### 1. Field of the Invention

The invention relates to power miter saw and more particularly to a linear guide mechanism and hinge connections of a power miter saw having improved characteristics.

### 2. Description of Related Art

U.S. Pat. No. 6,892,618 to the present inventor Chang discloses a circular sawing machine comprising a base; a saw seat movable relative to the base; and a link mechanism pivotally mounted between the base and the saw seat. The saw seat is linearly movable relative to the base. The link mechanism has a symmetrical structure so that the saw seat can be moved linearly relative to the base by linear movement of the link mechanism. The link mechanism includes a positioning seat secured on the base, two symmetrically opposite first links each having a first end mounted on the positioning seat, two symmetrically opposite second links each having a first end pivotally mounted on a second end of a respective one of the two first links, and two symmetrically opposite third links each having a first end pivotally mounted on a second end of a respective one of the two second links and a second end pivotally mounted on a connecting seat which is mounted on the saw seat.

While the device enjoys its success in the market, continuing improvements are constantly being sought.

### SUMMARY OF THE INVENTION

It is therefore one object of the invention to provide a power miter saw comprising a base; a table rotatably mounted on the base; a saw blade and motor mechanism configured to rotate a saw blade; and two linear guide mechanisms each connected to a rear support seat of the base using a lower positioning seat, and connected to the saw blade and motor mechanism using an upper connecting seat, thereby supporting the saw blade and motor mechanism; wherein the linear guide mechanism comprises a first link comprising a bifurcated first end including two opposite first through holes each having a conic, outwardly expanded mouth; a bifurcated second end including two opposite second through holes; and a fastener driven through the second through holes and two through holes of the connecting seat to fasten the first link and the connecting seat together; a second link comprising a bifurcated first end having two opposite first through hole having a bearing recess, and a bifurcated second end including two opposite second through holes; a biasing member disposed in two through holes of the lower positioning seat; two washers disposed at outer ends of the first through holes of the second link respectively; a cylindrical lining disposed in the first through holes of the second link; two bearings disposed at the bearing recesses respectively and engaging with two ends of the cylindrical lining respectively, each bearing being sandwiched between the washer and the cylindrical lining; and a pivot having a conic, outwardly expanded head and a receptacle at an end, the pivot driven through the first through holes of the first link, the washers, the bearings, the cylindrical lining, and the first through holes of the second link to receive a portion of a complimentary pivot in the receptacle so as to pivotably secure the first and second links together wherein the complimentary pivot has a conic, outwardly expanded head complimentarily secured to one conic, outwardly expanded mouth, and the conic, outwardly expanded head of the pivot is complimentarily secured to the other conic, outwardly expanded mouth; and a fastener driven through the second through holes of the second link, the biasing member, and the through holes of the lower positioning seat to fasten the second link and the lower positioning seat together.

The above and other objects, features and advantages of the invention will become apparent from the following detailed description taken with the accompanying drawings.

### BRIEF DESCRIPTION OF THE DRAWINGS

FIG. 1 is a perspective view of a power miter saw incorporating a first preferred embodiment of two linear guide mechanisms according to the invention;

FIG. 2 is a perspective view of the linear guide mechanisms and associated components;

FIG. 3 is another view of FIG. 2;

FIG. 3A is a view similar to FIG. 3 showing the locked linear guide mechanisms;

FIG. 4 is an exploded view of the linear guide mechanism and associated components;

FIG. 5 is a front view of FIG. 3;

FIG. 5A is a front view of FIG. 3 in part section;

FIG. 6 is a top view of the unlocked linear guide mechanisms;

FIG. 7 is a view similar to FIG. 6 showing the pivoting linear guide mechanisms;

FIG. 8 is a side elevation of the power miter saw with the linear guide mechanism being locked in a first position;

FIG. 9 is a view similar to FIG. 8 showing the movement of the saw blade and motor mechanism after unlocking the linear guide mechanism;

FIG. 10 is a top view of the linear guide mechanisms being locked in a first position;

FIG. 10A is a view similar to FIG. 10 showing the linear guide mechanisms being locked in a second position;

FIG. 11 is a view similar to FIG. 8 with the linear guide mechanism being locked in a second position;

FIG. 12 is a perspective view of a second preferred embodiment of the linear guide mechanisms and associated components;

FIG. 13 is an exploded view of the linear guide mechanism and associated components of FIG. 12;

FIG. 14 is a sectional view of the joining portion of the first and second links of the linear guide mechanism of FIG. 12; and

FIG. 15 is a side elevation of FIG. 14.

### DETAILED DESCRIPTION OF THE INVENTION

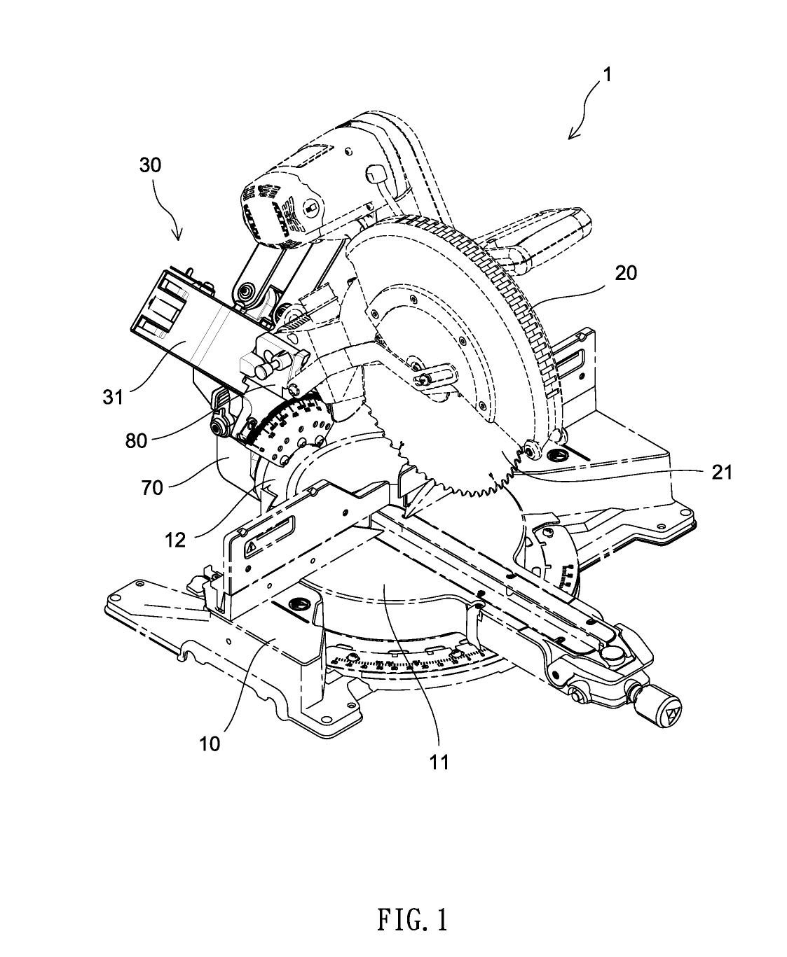

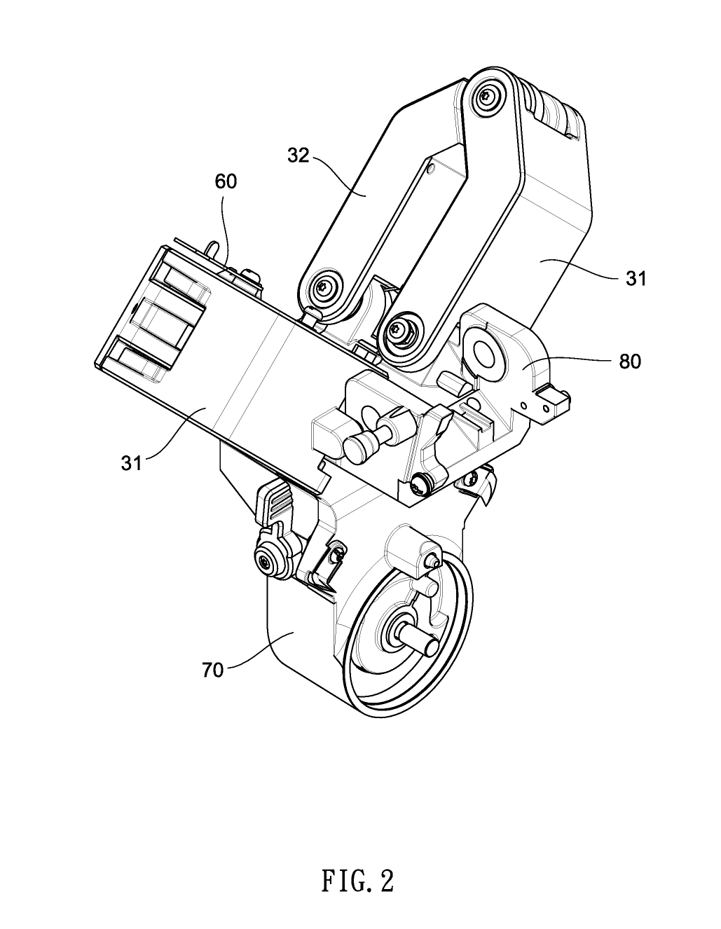

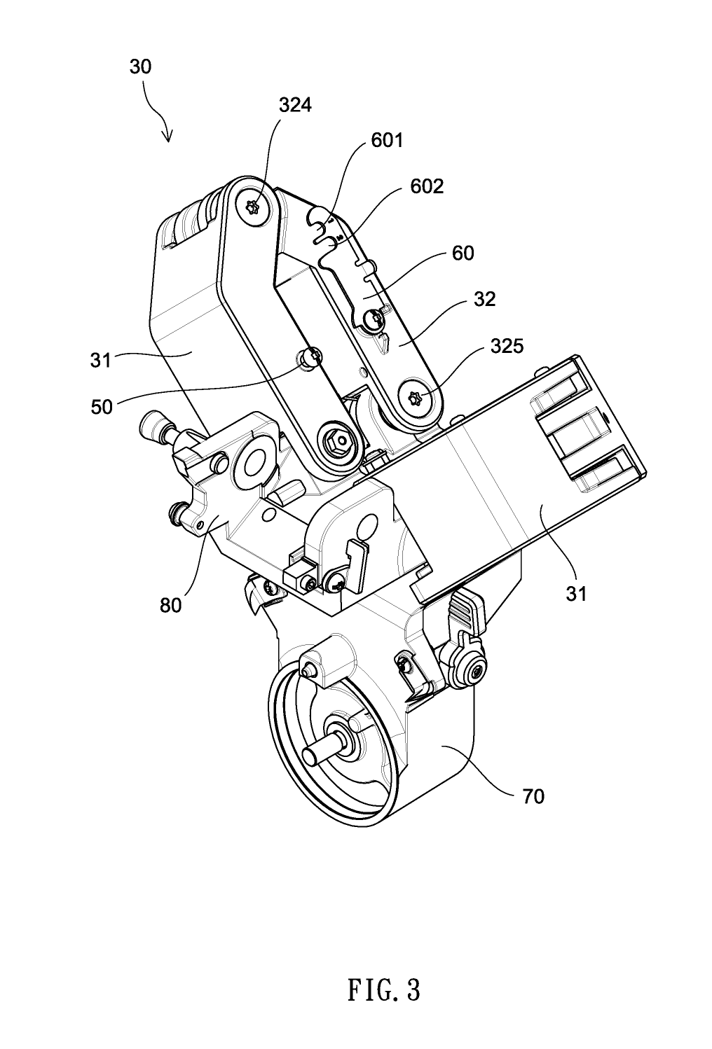

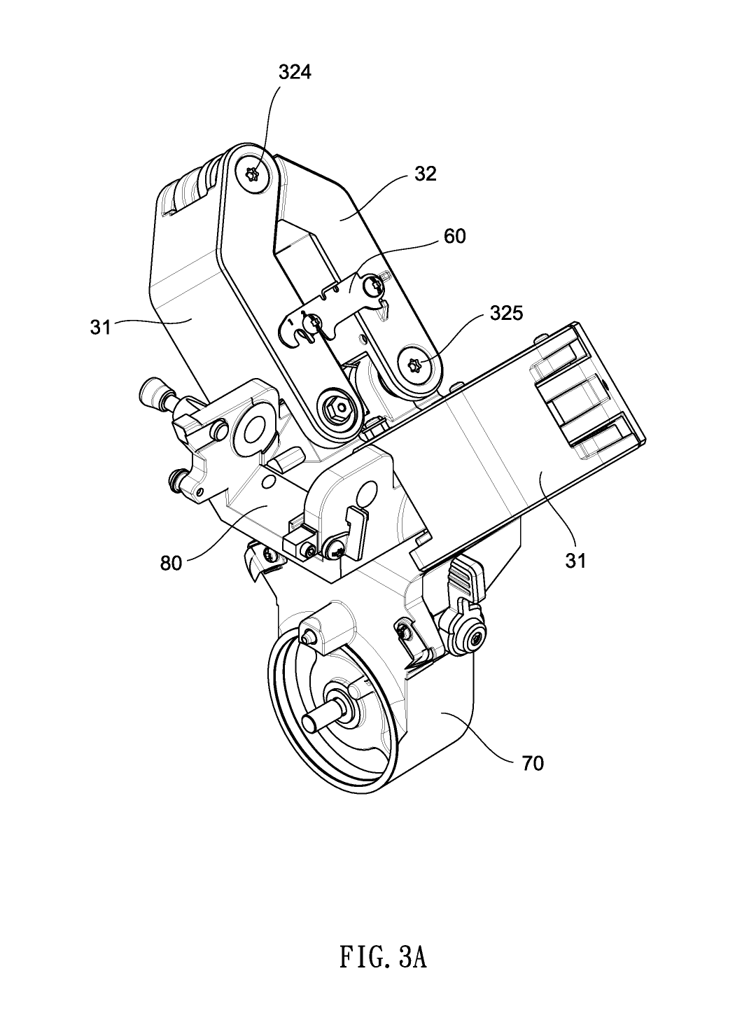

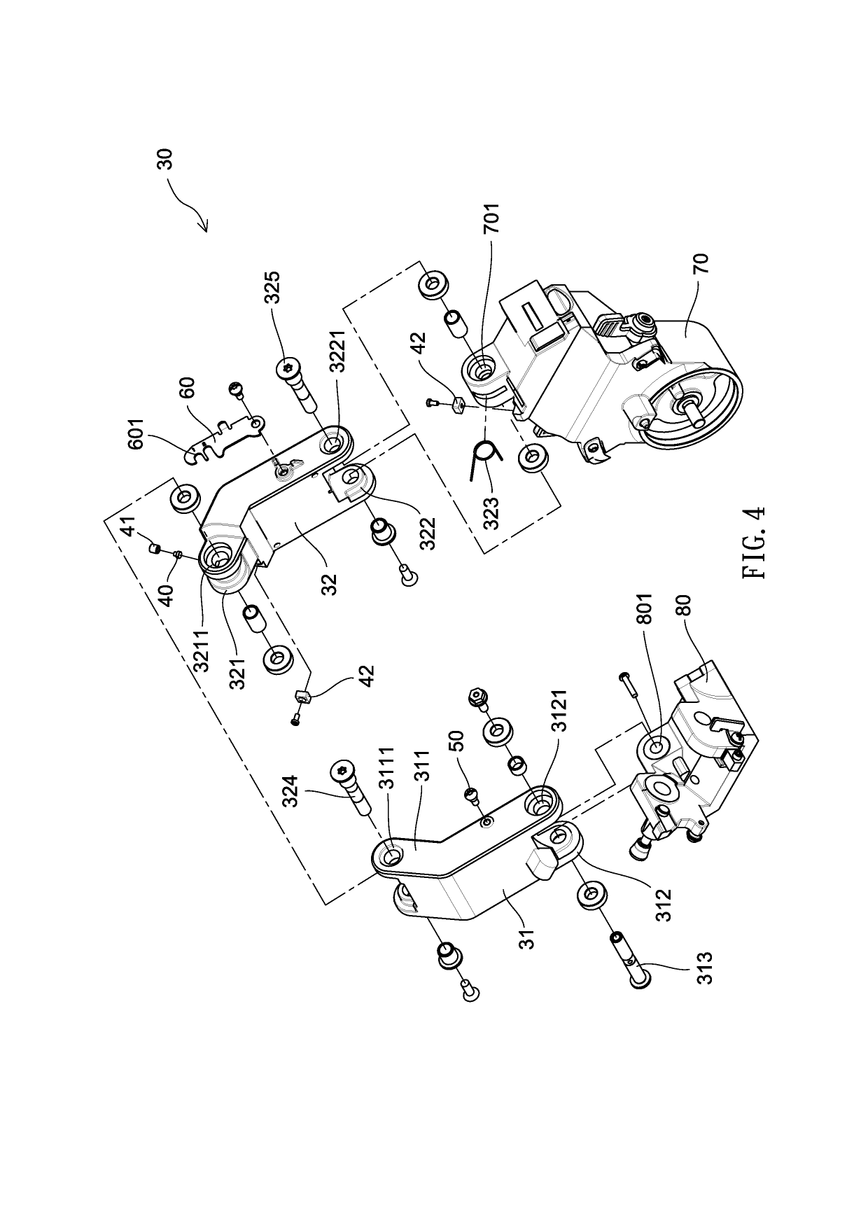

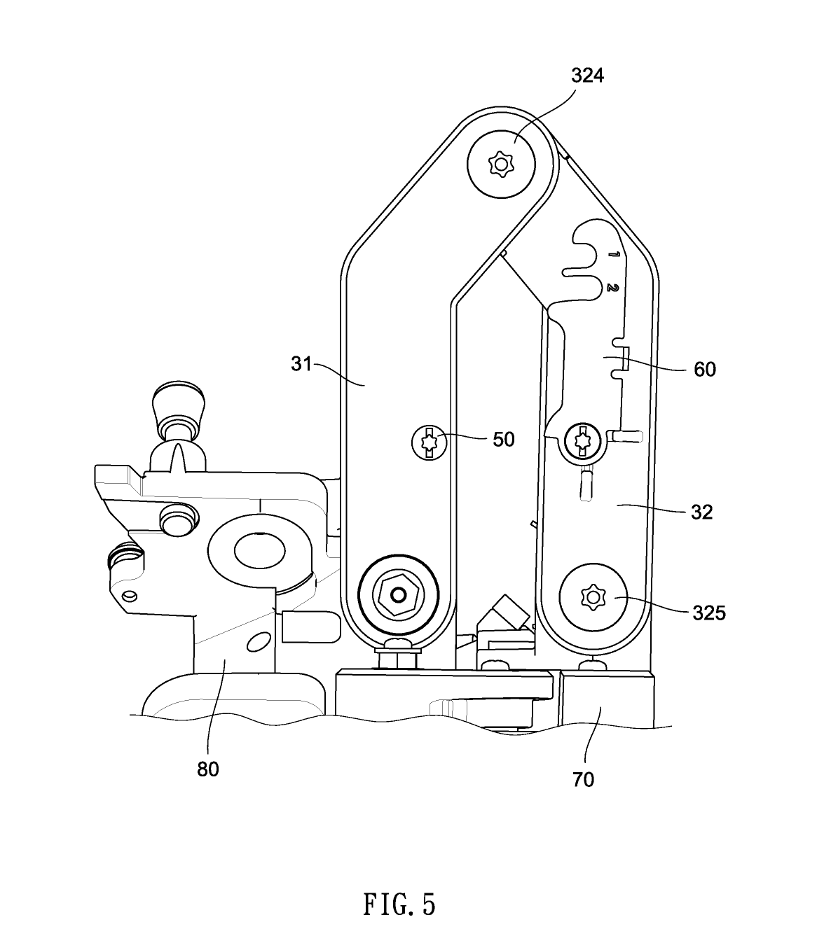

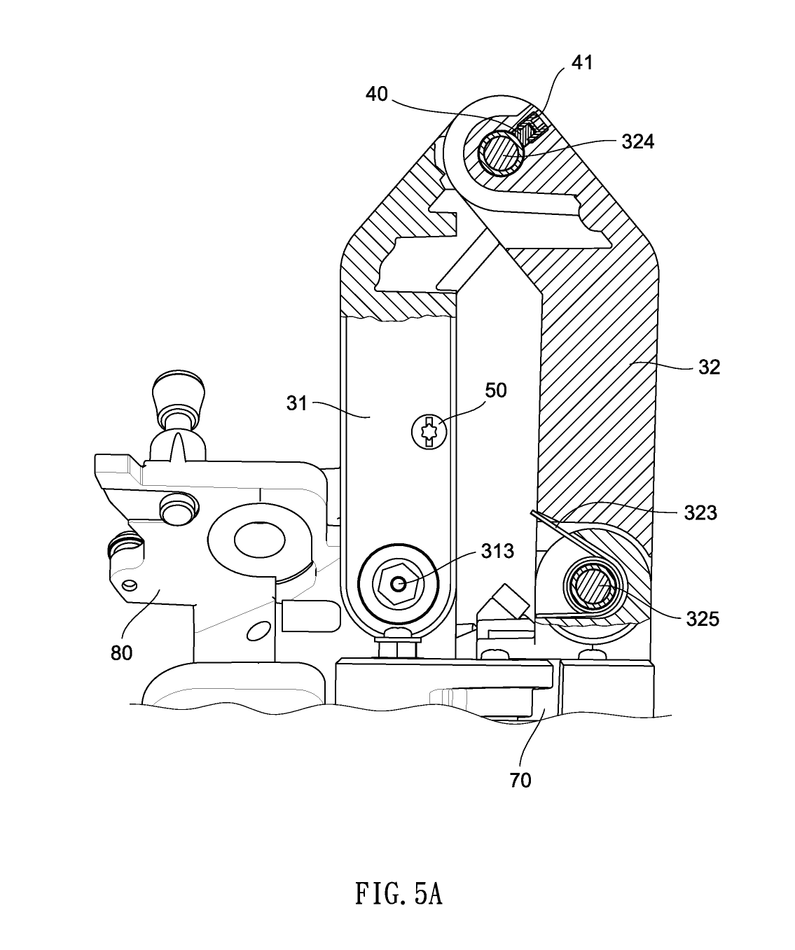

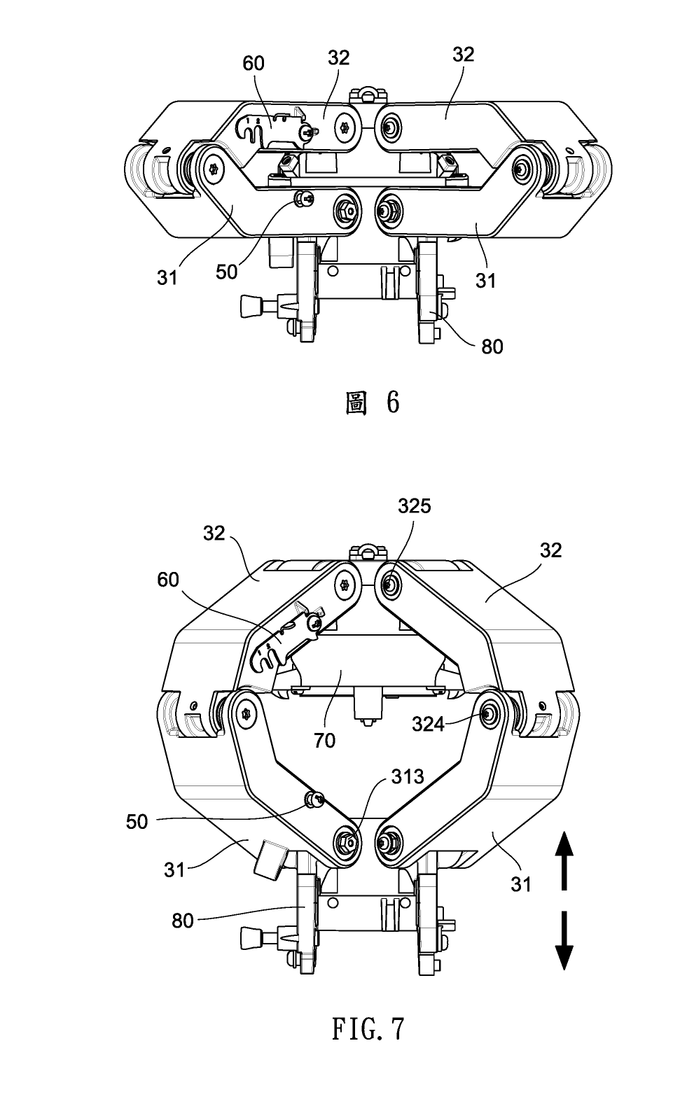

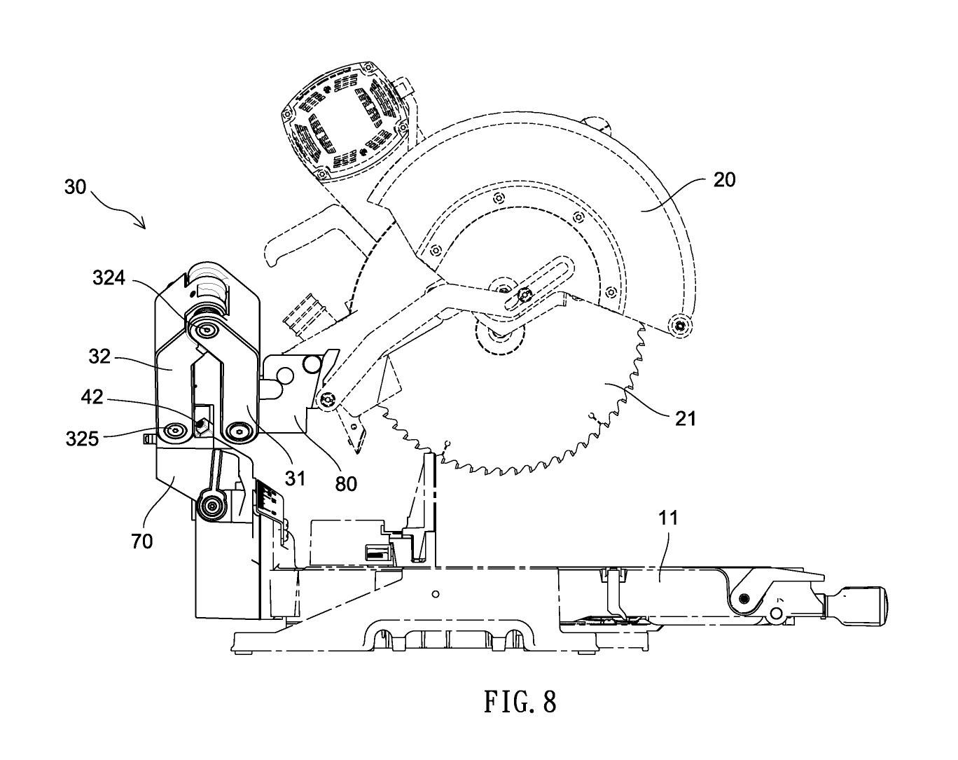

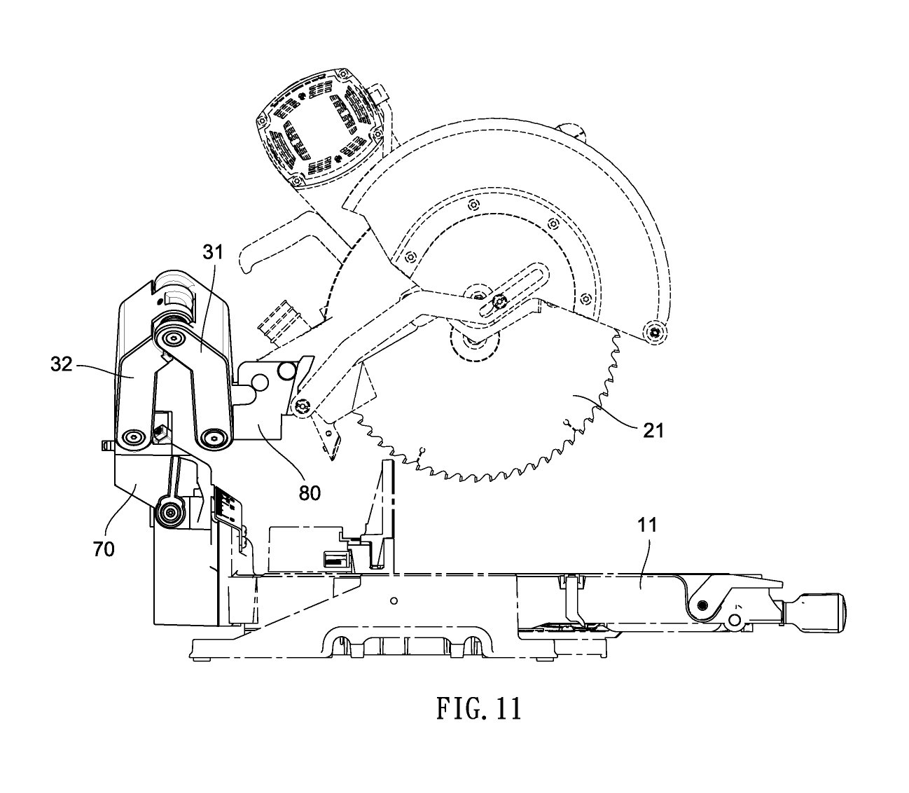

Referring to FIGS. 1 to 11, a power miter saw 1 in accordance with the invention comprises the following components as discussed in detail below.

A base 10 and a rotatable table 11 on the base 10 are provided. The table 11 is configured to receive a workpiece (not shown). A saw blade and motor mechanism 20 is configured to rotate a saw blade 21. Two linear guide mechanisms 30 of a first preferred embodiment as the subject of the invention are provided.

A lower positioning seat 70 interconnects the linear guide mechanisms 30 and a rear support seat 12 of the base 10. An upper connecting seat 80 interconnects the linear guide mechanisms 30 to the saw blade and motor mechanism 20. Thus, the saw blade and motor mechanism 20 is supported by the two symmetrically disposed linear guide mechanisms 30.

Each linear guide mechanism 30 comprises a first link 31 including a bifurcated first end 311 having two opposite first through holes 3110, and a bifurcated second end 312 having two opposite second through holes 3121; and a fastener 313 driven through the second through holes 3121 and two through holes 801 of the connecting seat 80 to fasten the first link 31 and the connecting seat 80 together.

The linear guide mechanism 30 further comprises a second link 32 including a bifurcated first end 321 having two opposite first through holes 3211, and a bifurcated second end 322 having two opposite second through holes 3221; a torsion spring 323 disposed in two through holes 701 of the positioning seat 70; a pivot 324 driven through the first through holes 3110 and the first through holes 3211 to pivotably secure the first and second links 31, 32 together; and a fastener 326 driven through the second through holes 3221, the torsion spring 323, and through holes 701 of the positioning seat 70 to fasten the second link 32 and the positioning seat 70 together. Thus, the second link 32 is configured as a spring-loaded member.

The linear guide mechanism 30 further comprises a friction member 40 in the first end 321 of the second link 32 contacting the pivot 324, an adjustment screw 41 disposed on the friction member 40 for adjusting friction between the pivot 324 and the friction member 40, and two catch blocks 42 secured to top of the positioning seat 70 and side of the second link 32 respectively, thereby limiting a pivotal angle of each of the first and second links 31, 32.

The linear guide mechanism 30 further comprises a projection 50 fastened on an outer surface of the first link 31, and a latch 60 pivotably secured to an outer surface of the second link 32 and including a first slot 601 at a first end, and a second slot 602 adjacent to the first slot 601.

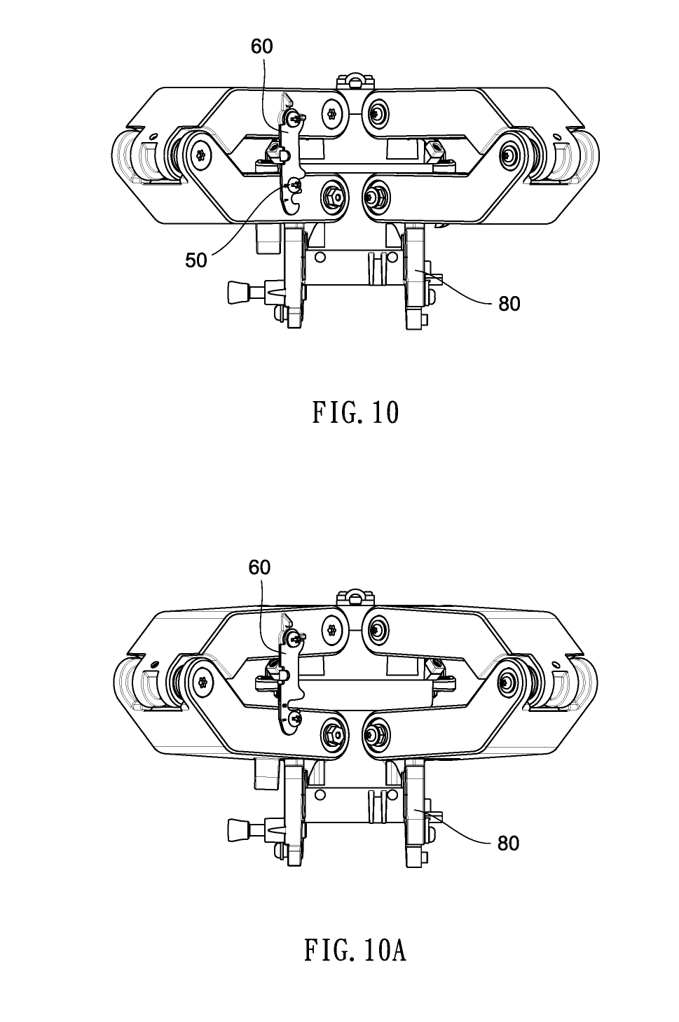

In a first locked position, the second slot 602 is placed on the projection 50 with a distance between the first link 31 and the second link 32 being minimum (see FIG. 10). In a second locked position, the first slot 601 is placed on the projection 50 with a distance between the first link 31 and the second link 32 being greater than the minimum distance so as to accommodate a workpiece to be cut (see FIG. 10A).

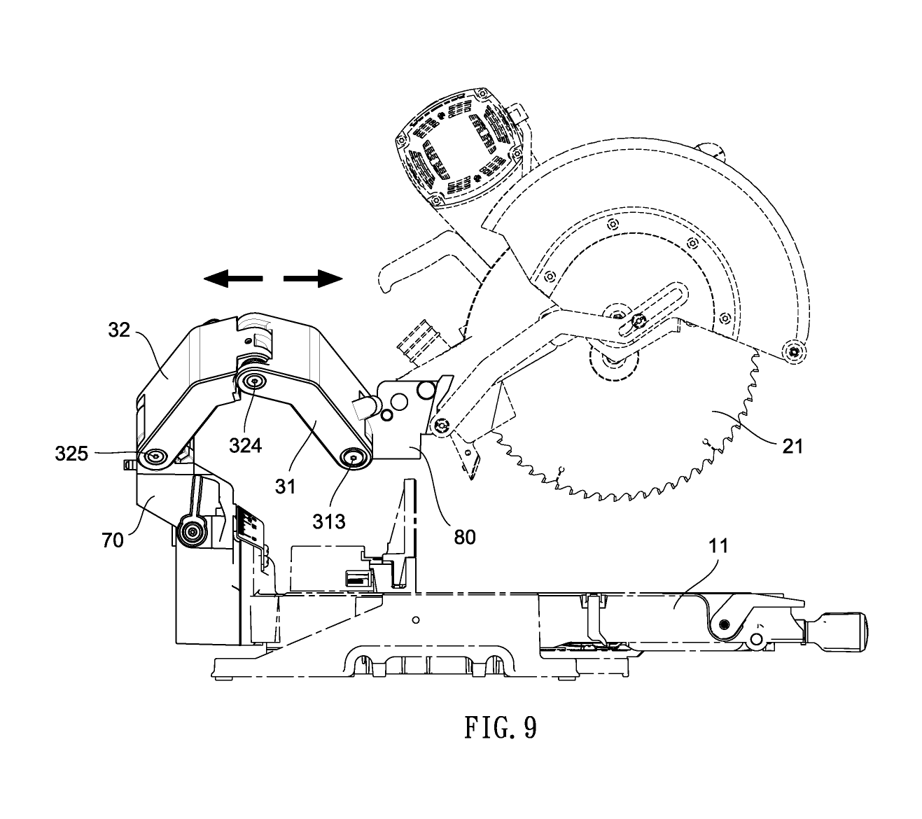

In an operating position (see FIG. 9), the first and second links 31, 32 are unlocked by the latch 60. Thus, each linear guide mechanism 30 may move along a predetermined linear path in either a forward or a rearward direction.

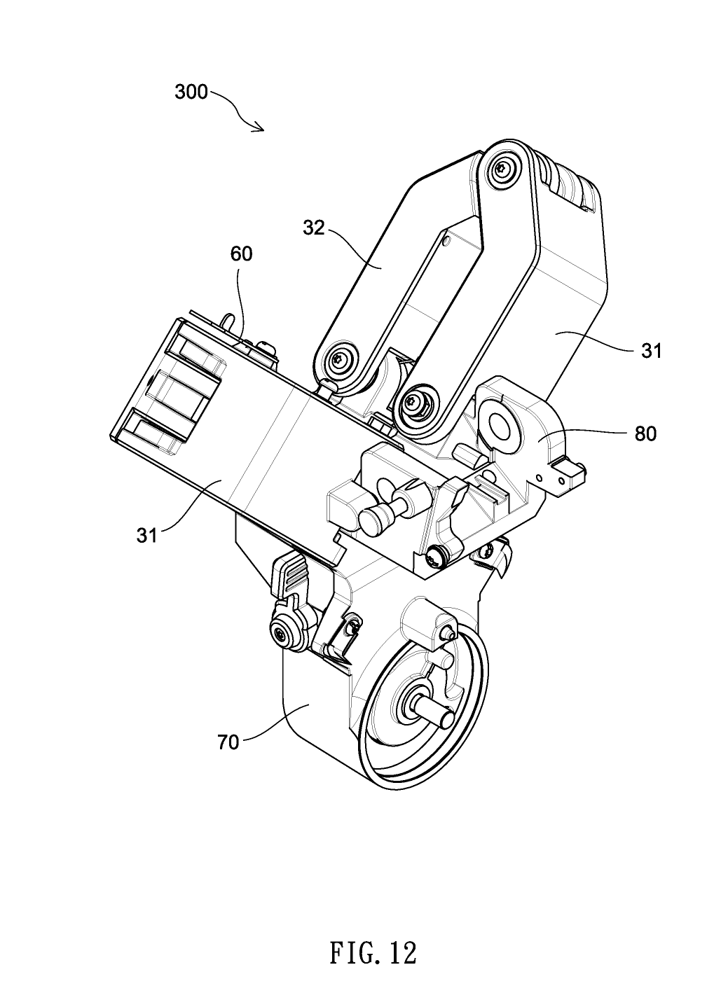

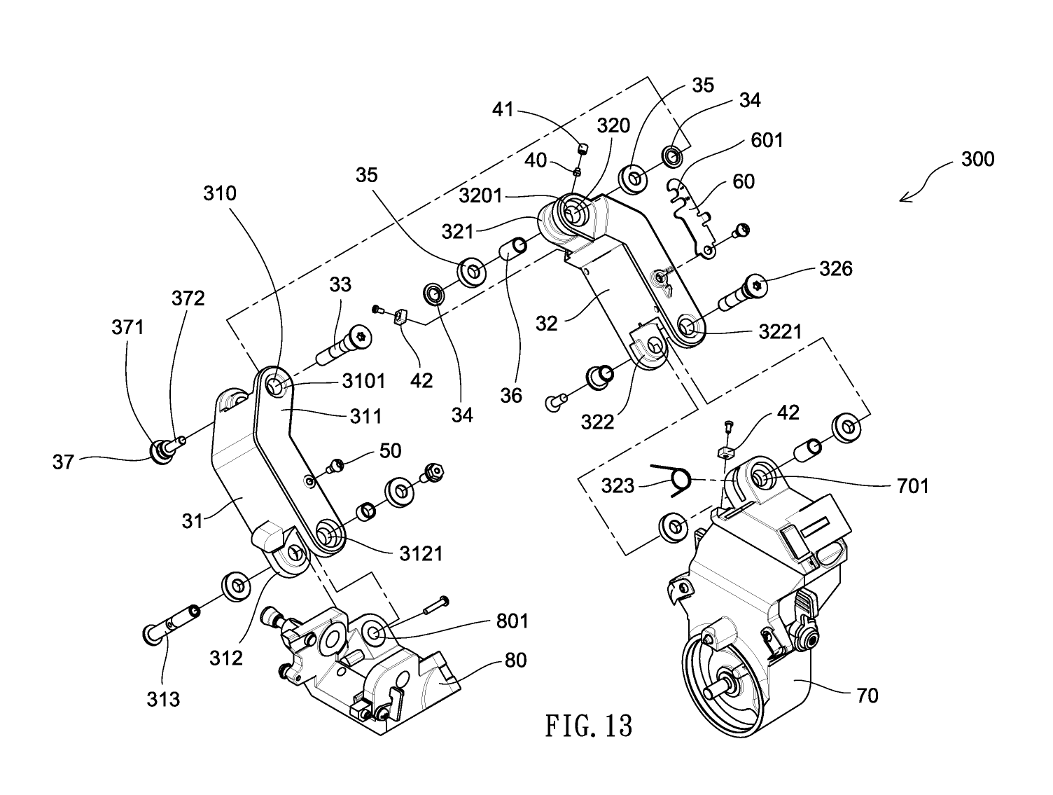

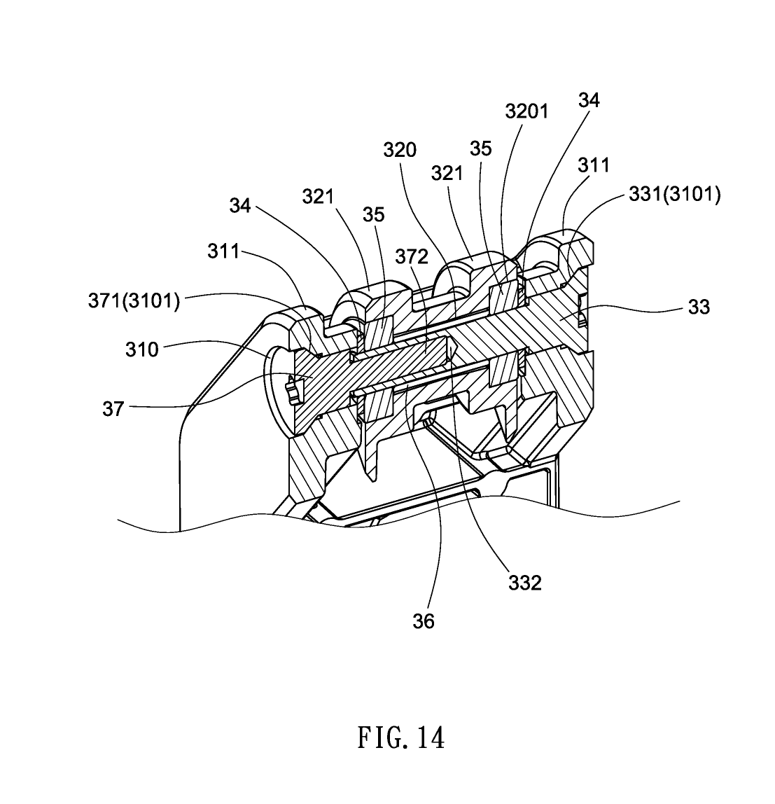

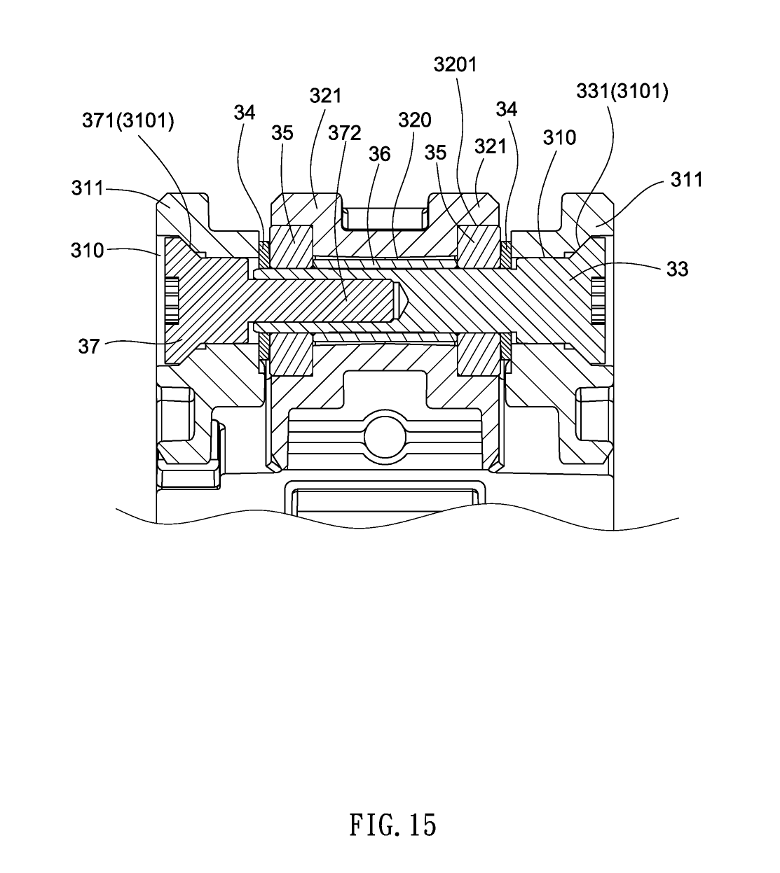

Referring to FIGS. 12 to 15, two linear guide mechanisms 300 of a second preferred embodiment of the invention are shown. Characteristics of the linear guide mechanism 300 of the second preferred embodiment are described in detail below in conjunction with FIGS. 1 to 11.

Each linear guide mechanism 300 comprises a first link 31 including a bifurcated first end 311 having two opposite first through holes 310 each having a conic, outwardly expanded mouth 3101, and a bifurcated second end 312 having two opposite second through holes 3121; and a fastener 313 driven through the second through holes 3121 and two through holes 801 of the connecting seat 80 to fasten the first link 31 and the connecting seat 80 together.

The linear guide mechanism 300 further comprises a second link 32 including a bifurcated first end 321 having two opposite first through holes 320 each having a bearing recess 3201, and a bifurcated second end 322 having two opposite second through holes 3221; a torsion spring 323 disposed in two through holes 701 of the positioning seat 70; two washers 34 disposed at outer ends of the first through holes 320 respectively; a cylindrical lining 36 disposed in the first through holes 320; two bearings 35 disposed at the bearing recesses 3201 respectively and engaging with two ends of the cylindrical lining 36 respectively, each bearing 35 being sandwiched between the washer 34 and the cylindrical lining 36; a pivot 33 having a conic, outwardly expanded head 331 and a receptacle 332 at an end, the pivot 33 driven through the first through holes 310, the washers 34, the bearings 35, the cylindrical lining 36, and the first through holes 320 to receive the shank of a complimentary pivot 37 in the receptacle 332, the complimentary pivot 37 having a conic, outwardly expanded head 371 complimentarily secured to one conic, outwardly expanded mouth 3101, and a shank 372 complimentarily fastened in the receptacle 332 of the pivot 33. Also, the conic, outwardly expanded head 331 of the pivot 33 is complimentarily secured to the other conic, outwardly expanded mouth 3101. As such, the first and second links 31, 32 are pivotably secured together. The second link 32 further comprises a fastener 326 driven through the second through holes 3221, the torsion spring 323, and the through holes 701 of the positioning seat 70 to fasten the second link 32 and the positioning seat 70 together. Thus, the second link 32 is configured as a spring-loaded member.

The provision of the washers 34 can increase stability in operation by sandwiching one washer 34 between one side of the first end 311 of the first link 31 and the second link 32, and sandwiching the other washer 34 between the other side of the first end 311 of the first link 31 and the second link 32. Further, the joining surface of the washer 34 and the first end 311 of the first link 31 is flat with increased contact area. Furthermore, the heads of both the pivot 33 and the complimentary pivot 37 are complimentarily joined two sides of the first end 311 of the first link 31 for fastening purpose. As a whole, not only operation is made smooth but also the linear guide mechanisms 300 are robust and reliable.

The linear guide mechanism 300 further comprises a friction member 40 in the first end 321 of the second link 32 contacting the pivot 33, an adjustment screw 41 disposed on the friction member 40 for adjusting friction between the pivot 33 and the friction member 40, and two catch blocks 42 secured to a top of the positioning seat 70 and one side of the second link 32 respectively, thereby limiting a pivotal angle of each of the first and second links 31, 32.

The linear guide mechanism 300 further comprises a projection 50 fastened on an outer surface of the first link 31, and a latch 60 pivotably secured to an outer surface of the second link 32 and including a first slot 601 at a first end, and a second slot (not numbered) adjacent to the first slot 601.

While the invention has been described in terms of preferred embodiments, those skilled in the art will recognize that the invention can be practiced with modifications within the spirit and scope of the appended claims.

What is claimed is:

1. A power miter saw comprising:
a base;
a table rotatably mounted on the base;
a saw blade and motor mechanism configured to rotate a saw blade; and
two linear guide mechanisms each connected to a rear support seat of the base using a lower positioning seat, and connected to the saw blade and motor mechanism using an upper connecting seat, thereby supporting the saw blade and motor mechanism;
wherein the linear guide mechanism comprises:
a first link comprising a bifurcated first end including two opposite first through holes each having a conic, outwardly expanded mouth; a bifurcated second end including two opposite second through holes; and a fastener driven through the second through holes and two through holes of the connecting seat to fasten the first link and the connecting seat together;
a second link comprising a bifurcated first end having two opposite first through holes each having a bearing recess, and a bifurcated second end including two opposite second through holes; a biasing member disposed in two through holes of the lower positioning seat; two washers disposed at outer ends of the first through holes of the second link respectively; a cylindrical lining disposed in the first through holes of the second link; two bearings disposed at the bearing recesses respectively and engaging with two ends of the cylindrical lining respectively, each bearing being sandwiched between the washer and the cylindrical lining; and
a pivot having a conic, outwardly expanded head and a receptacle at an end, the pivot driven through the first through holes of the first link, the washers, the bearings, the cylindrical lining, and the first through holes of the second link to receive a portion of a complimentary pivot in the receptacle so as to pivotably secure the first and second links together wherein the complimentary pivot has a conic, outwardly expanded head complimentarily secured to one conic, outwardly expanded mouth, and the conic, outwardly expanded head of the pivot is complimentarily secured to the other conic, outwardly expanded mouth; and a fastener driven through the second through holes of the second link, the biasing member, and the through holes of the lower positioning seat to fasten the second link and the lower positioning seat together.

2. The power miter saw of claim 1, wherein one washer is sandwiched between one side of the first end of the first link and one bearing, and the other washer is sandwiched between the other side of the first end of the first link and the other bearing.

3. The power miter saw of claim 1, wherein the complimentary pivot further comprises a shank complimentarily fastened in the receptacle of the pivot.

4. The power miter saw of claim 1, wherein heads of both the pivot and the complimentary pivot are complimentarily joined two sides of the first end of the first link.
